(19) United States
(12) Patent Application Publication
(10) Pub. No.: US 2025/0342261 A1
(43) Pub. Date: Nov. 6, 2025

(54) METHOD FOR PROVISIONING AND DE-PROVISIONING JUST-IN-TIME, PURPOSE-BASED ACCESS FOR IDENTITIES WITHIN APPLICATIONS

(71) Applicants: Subramanian Rama, Irving, TX (US); Nathan Wong, Seattle, WA (US); Ankush Deep, Oakland, CA (US); Suraj Ranganath, Bangalore (IN)

(72) Inventors: Subramanian Rama, Irving, TX (US); Nathan Wong, Seattle, WA (US); Ankush Deep, Oakland, CA (US); Suraj Ranganath, Bangalore (IN)

(21) Appl. No.: 19/194,524

(22) Filed: Apr. 30, 2025

Related U.S. Application Data
(60) Provisional application No. 63/642,929, filed on May 6, 2024.

(51) Int. Cl. G06F 21/60

(52) U.S. Cl. CPC G06F 21/604; G06F 2221/2141

(57) ABSTRACT

A system for facilitating just-in-time, purpose-based access control (JITPBAC for identities within Cloud, SaaS applications. Using this method, identities within Cloud, SaaS applications will have no access by default. All access that is required by owners of the identities will be organized under Purposes, which represent a list of identity owners as well as a list of entities accessible within specific applications. When an identity owner is listed under a Purpose, that identity owner is eligible to be assigned the Purpose. To become eligible for a Purpose that an identity owner has no access to, the identity owner must request access to the Purpose and subsequently be approved by a risk manager within the organization. Additional information must be provided as a part of the request including but not limited to how long the identity owner should be assigned to the Purpose, what time of day the identity owner is expected to use the Purpose, and how many extensions can be requested for the assigned Purpose as well as the duration of the extension.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application is a Utility Patent application claiming priority to U.S. Provisional Patent Application Ser. No. 63/642,929, filed on May 6, 2024, which is incorporated by reference herein in its entirety.

### BACKGROUND OF THE INVENTION

### 1) Field of the Invention

The invention relates to the field of provisioning and de-provisioning just-in-time, purpose-based access for identities within applications, and more particularly, to a method of provisioning and de-provisioning for identities within applications.

### 2) Description of Related Art

A common vector of attack by malicious actors against organizations, such as corporations or government entities, is by way of acquiring compromised credentials of identities within third-party, Cloud, Saas (Software as a Service) applications. These applications include but are not limited to cloud service providers, HRIS systems, and document stores populated with sensitive information. To mitigate the damage inflicted by compromised identities within these applications, it is common for applications to implement an ABAC (Attribute-Based Access Control) or RBAC (Role-based Access Control) model to assign access to identities by which role or attribute is appropriate. This aims to reduce the damage that attackers can inflict by intentionally limiting the access of certain identities.

However, one of the pitfalls of these models is the fact that these identities keep their assigned roles or attributes in perpetuity, meaning that access is not de-provisioned until the owner of the identity no longer requires access for their current job role or leaves the organization entirely. In addition, the identity will have access to their assigned roles or attributes even when the owner of the identity does not immediately require them for a task. When attackers gain control of these identities, they will have access within these applications as long as the identities' access remains provisioned. Therefore, a need exists to inhibit the ability of malicious actors to inflict damage to the organization by limiting the scope and temporal bounds of access within SaaS applications.

Another issue related to organizational efficiency and security manifests due to the sheer number of Cloud, SaaS applications that organizations rely on. Since each application is typically managed by an application owner it can be cumbersome and error prone to provision and de-provision access to identity owners whose access spans across many applications. It can also be time consuming and take hours to successfully provision and de-provision per identity owner. When an identity owner leaves an organization, some of their identities could remain provisioned if the corresponding application owners are not aware of the situation, which poses a security risk that gets magnified the longer each identity remains provisioned. Hence, there exists a need for a centralized method for provisioning and de-provisioning an identity owner identity based on changes within the organization.

### BRIEF SUMMARY OF THE INVENTION

A multi-agent identity security governance and administration system including a network of intelligent agents deployed by the system. Each intelligent agent specializes in at least one distinct aspects of identity security. Each of the intelligent agents operate collaboratively to enforce access policies, detect anomalies, manage user privileges, and ensure compliance with regulatory requirements. The system leverages multi-agent technology in operations performed by the system.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 shows a diagram of the multi-agent identity security governance and administration system according to the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

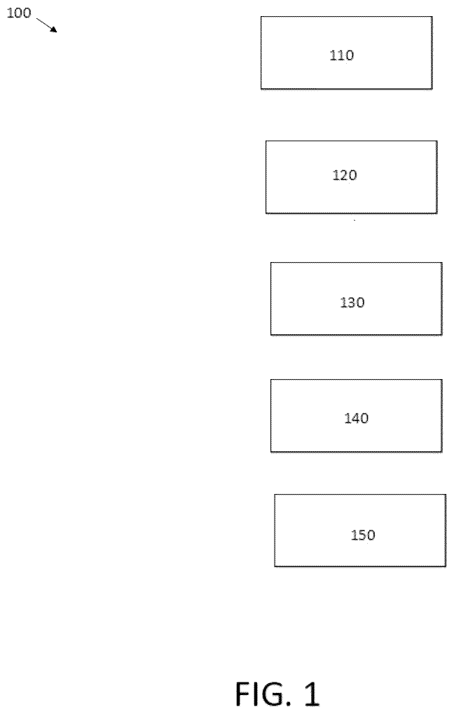

FIG. 1 shows a flowchart 100 for a method for provisioning and de-provisioning just-in-time, purpose-based access for identities within application. The system facilitates just-in-time, purpose-based access control (JITPBAC for identities within Cloud, SaaS applications. Using this method, identities within Cloud, SaaS applications will have no access by default. All access that is required by owners of the identities will be organized under purposes, which represent a list of identity owners as well as a list of entities accessible within specific applications. When an identity owner is listed under a purpose, that identity owner is eligible to be assigned the purpose. To become eligible for a purpose that an identity owner has no access to, the identity owner must request access 110 to the purpose and subsequently be approved 120 by a risk manager within the organization. Additional information must be provided 130 as a part of the request including but not limited to how long the identity owner should be assigned to the purpose, what time of day the identity owner is expected to use the purpose, and how many extensions can be requested for the assigned purpose as well as the duration of the extension. In some cases, an identity owner may not become eligible to be assigned a purpose if there existed a constraint that would prevent assignment. Similarly to purposes, constraints represent a list of identity owners, a list of entities accessible within a specific application, as well as an indicator to whether or not the identity owners are prevented from accessing the list of entities provided or if the identity owners can only access the list of entities provided. A constraint cannot be created if there exists a purpose and violates the constraint. Conversely, a purpose cannot be created if it violates an existing constraint. Once the identity owner is eligible for the purpose, the identity owner will have their identities provisioned automatically 140 at the start of the time window specified each working day. Provisioning will not occur on days that the identity owner is not working. Alternatively, they may make a manual request to assign the purpose to themselves outside of the specified time window as long as it is approved by a risk manager. If the identity owner is assigned the purpose, access is provisioned for their identities. At any time that the purpose is provisioned, the identity owner may decide to relinquish access by un-assigning themselves from the purpose.

Additionally, if the time window for the identity owner's access to the purpose is out of bounds, as described in the eligibility request, de-provisioning 150 will occur automatically at the end of the specified time window. Prior to the time window going out of bounds, the identity owner will be notified of the impending de-provisioning. The identity owner may act on this notification by requesting an extension to prevent automatic de-provisioning if allowed by the purpose. At any time, a risk manager can un-assign an identity owner from a purpose as well as remove their eligibility.

In urgent situations, certain identity owners will need to be assigned purposes without approval. In this case, identity owners that have had eligibility for a purpose approved in the past will be able to invoke the “break glass” mode to gain access. This will trigger notifications to all concerned parties at the organization including risk managers.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A method for using a multi-agent identity security governance and administration system, the method comprising:
an identity owner requesting access to the purpose;
a risk manager approving access of the identity owner within the organization;
the identity owner providing additional information as a part of the request including but not limited to:
how long the identity owner should be assigned to the purpose;
what time of day the identity owner is expected to use the purpose;
how many extensions can be requested for the assigned purpose; and
a duration of the extension;
wherein an identity owner may not become eligible to be assigned a purpose if there existed a constraint that would prevent assignment;
wherein constraints represent:
a list of identity owners;
a list of entities accessible within a specific application;
an indicator to whether the identity owners are prevented from accessing the list of entities provided or if the identity owners can only access the list of entities provided;
wherein a constraint cannot be created if there exists a purpose and violates the constraint;
wherein a purpose cannot be created if it violates an existing constraint;
wherein once the identity owner is eligible for the purpose, the identity owner will have their identities provisioned automatically at the start of the time window specified each working day; and
wherein at any time that the purpose is provisioned, the identity owner may decide to relinquish access by un-assigning themselves from the purpose,
wherein if the time window for the identity owner's access to the purpose is out of bounds, as described in the eligibility request, de-provisioning will occur automatically at the end of the specified time window;
wherein prior to the time window going out of bounds, the identity owner will be notified of the impending de-provisioning; and
wherein the identity owner may act on this notification by requesting an extension to prevent automatic de-provisioning if allowed by the purpose;
wherein at any time, a risk manager can un-assign an identity owner from a purpose as well as remove their eligibility.
